(19) United States
(12) Patent Application Publication
(10) Pub. No.: US 2026/0217386 A1
(43) Pub. Date: Jul. 30, 2026

(54) AIRCRAFT TIRE SECURING SYSTEM

(71) Applicant: SF Supply Chain (Hong Kong) Limited, Hong Kong (CN)

(72) Inventors: Chun Fai chang, Hong Kong (CN); Wing Kin Yip, Hong Kong (CN)

(73) Assignee: SF Supply Chain (Hong Kong) Limited, Hong Kong (CN)

(21) Appl. No.: 19/037,561

(22) Filed: Jan. 27, 2025

(51) Int. Cl. B64F 5/50

(52) U.S. Cl. CPC B64F 5/50

(57) ABSTRACT

A tire securing system includes a rack frame having a base platform supporting a plurality of vertical bars extending vertically from three sides of the base platform. A movable slanted step is activated by a first lever mechanism with a handle. The movable slanted step is disposed on the one side and the plurality of vertical bars on the three sides of the base platform forms an entry way to receive tires. A tire resting plate is connected to the base platform and has one end thereof connected to the movable slanted step via a hinge. A tire stopper bar is disposed at the other end of the tire resting plate. A plurality of guarding bars extends diagonally from the at least one substantially horizontal bar to the base platform. One or more restraining lines is connected to the plurality of guarding bars for securing the tires.

### FIELD OF THE INVENTION

Aspects of the present invention relate generally to tire rack. In particular, embodiments of the invention relate to storing aircraft tires vertically with a portable and stackable rack.

### BACKGROUND

Transport and storage of tires is cumbersome and if not done properly, can be dangerous. Tires are heavy and bulky. Tires have previously been stored by simply placing them on the ground in stacks, generally parallel to the floor surface on which they rest. It has been suggested that various rack arrangements may be utilized to store tires above a floor surface or other support surface. For example, various rack systems are disclosed in the prior art where they are configured to store the tires in the upright position, one next to each other without any separation, on two parallel bars spaced appropriately to allow the outer surface of the circumference of a tire to rest in the space between the bars.

The tires in this configuration generally support each other, the side of one tire resting generally on the side of another tire, and so on until the side of one tire rests against the side of one edge of the rack. This is fine in a garage or a location where the tires are unlikely to move or be jostled until someone goes to take a tire from the rack. However, in situations where tires or tire racks may be subject to movement, especially in situations of transport, it is desirable to have the tire secured in some manner other than just sitting in its rack location and supported by the tire next to it or the rack edge.

Other prior art requires that once the tires are rolled in place, straight or substantially straight bars are positioned in parallel to the upright tires on each end with an e-track system so that a movable arm may secure to the e-track system on the one end while the other end securing it with the bars. Such system appears to be securing the tires in place, but can be difficult to the operator who must reach to the back of the rack and secure the movable arm to the e-track system.

### SUMMARY OF THE INVENTION

Embodiments of the invention improve over the prior art where the rack eliminate the need for the e-track system. Rather, the rack includes a movable entry step adjustable or activated by a side handle to block the tires from rolling out once the tires are positioned on the platform. In another embodiment, the upright tires are secured by a chain, which are removably secured to the two side bars of the platform. Other embodiments of the invention may further lower the tire resting platform to slightly allow the upright tires to roll into the rack platform to further prevent the tires from rolling out.

### BRIEF DESCRIPTION OF THE DRAWINGS

The present disclosure may be better understood by references to the detailed description when considered in connection with the accompanying drawings. The components in the figures may not necessarily be to scale, emphasis instead being placed upon illustrating the principles of the invention. In the figures, like reference numerals designate corresponding parts throughout the different views.

FIG. 1 is a perspective view of an aircraft tire securing system according to one embodiment.

FIG. 2 is a side view of the aircraft tire securing system according to one embodiment.

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

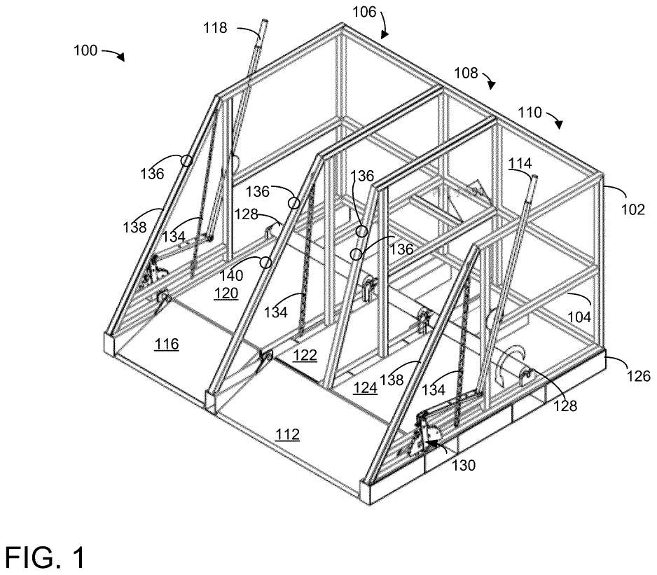

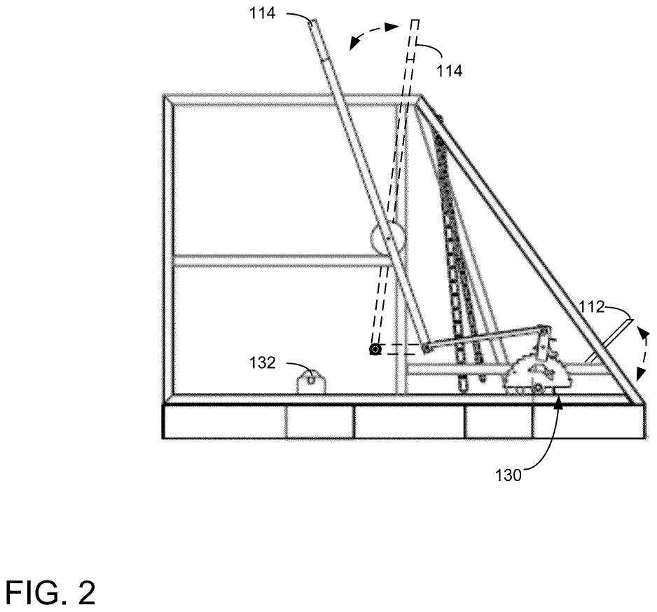

Referring now to FIGS. 1-2, a tire securing system 100 is designed to receive and store tires. In one embodiment, the tires may be aircraft or truck tires with dimensions of 44″ (diameter)×16″ (width) Type VII, 44.5″×16.5″-18″ Type VII tires. It is to be understood that other tire dimensions may be used without limitation.

In one embodiment, the tire securing system 100 includes a frame with a base platform 126, a plurality of substantially vertical bars 102 and reinforcing substantially horizontal bars 104. In another embodiment, the system 100 may further include a plurality of guarding bars 138 extending diagonally from the at least one substantially horizontal bar 104 to the base platform 126. In one embodiment, the system 100 may include a number of configurations. As shown in FIG. 1, three sections 106, 108 and 110 may be arranged in as one unit of the system 100. In one aspect, the section 106 may have a width to receive two tires while the section 108 may have a width to receive just one tire. Further, in another embodiment, the sections 108 and 110 may be constructed as one unit so that one movable slanted step or movable plate 112 with one handle 114 and a first lever mechanism 116 may be used. In another embodiment, the system 100 may just have sections 106, 108 and 110, individually. For example, as shown in FIG. 1, the system 100 may include the section 106 having a handle 118 and a movable slanted step or movable plate 116 for receiving two tires at once. The system 100 may also include the section 108 to receive one tire. No handle is configured for the section 108. The section 110 may include the handle 114 to activate the plate 112 to cover both sections 108 and 110.

In a further aspect, the system 100 further includes a tire resting plate (120, 122, and 124). In one embodiment, the plate 120, 122 or 124 may be connected to the base platform 126. In one embodiment, the plate 120, 122 or 124 may be leveled or parallel to the ground. In another embodiment, a stoppage bar 128 may be disposed at one end of the plate 120, 122, and 124. In one example, the bar 128 may be rotatable about a securing mechanism 132 to the base platform 126.

In a further embodiment, the movable plate 112 or 116 may be connected via a hinge to another distal end of the plate 120, 122, and 124. In one aspect, the movable plate 112 and 116 may be movable by the handle 114 and 118, respectively. For example, as shown in FIG. 1, the plate 112 or 116 may initially be in a resting state where it is angled with respect to the plate 120, 122 and 124. For example, in the resting state, the plate 112 or 116 is angled with respect to an x-axis of the plate 120, 122, and 124. In another example, the plate 120, 122, and 124 may be connected to the base platform 126 above a bottom footing such that one end of the plate 112 or 116 is closer to the ground level than the end where it is hinged to the plate 120, 122, and 124.

In another embodiment, the plate 112 or 116 may be leveled with the plate 120, 122, and 124 instead of the being angled so that it is easier to for the tire to be rolled to rest on the plate 120, 122, and 124.

In a further example, once the tire is ready to be stored, the system 100, which the configurations of the sections 106, 108 and 110, one or more tires may be rolled into the respective positions of the sections 106, 108, and 110.

Once the tire is rolled onto the plates 120, 122, and 124, a user may use the handle 114 or 118 to raise the plate 112 or 116, respectively. In one aspect, a first lever mechanism 130 may be used to connect the handle to the hinge of the plate 112 as to raise it, as shown in FIG. 2. It is also to be understand that with the activation of the handle 114, the plate 112 may also be lowered, as shown in FIG. 2.

In other words, once the tire to be stored is rolled onto the plate 124, for example, the user may pull the handle to raise the plate 112 to prevent the tire from rolling away from the plate 124 and the plate 112 is in an activated state. In one embodiment, the lever mechanism 130 may be locked in the activated state. In one aspect, a tip of the handle may be rotated to activate or deactivate the locking feature of the lever mechanism 130.

Moreover, the system 100 may include a chain 134 and a loop 136. In one aspect, the chain 134 may include a hook or similar attaching mechanism to secure the chain to the loop 136 as an added security to secure the tire on the plate 120, 122, and 124. It is understood other securing mechanism than hook and loop may be used without departing from the scope and spirit of the aspects of the invention.

In yet another embodiment, the system 100 may further include a second lever mechanism to lower the plate 120, 122, and 124 once the tire is on top of it. For example, the handle 114 may include a button or other actuating element to lower the plate 120, 122, and 124. In one aspect, the second lever mechanism may be disposed under the plate 120, 122, and 124 near the bar 128. Again, the degree of movement of lowering the plate 120, 122 and 124 may be small but, due to gravity and the weight of the tire, the tire may rest on the bar 128 and the plate 120, 122, and 124.

In yet another embodiment, the plate 120, 122 and 124 may include a spring disposed under the distal end away from the plate 112. For example, with such configuration, before the tire is rolled into place, the plate is in a resting position. Once the tire is rolled in place, the weight of the tire may press on the spring so that the plate 120, 122, and 124 may be tilted away from the plate 112, creating a slanted surface for the tire. The tire would exert more force or weight on the bar 128 and the plate 120, in one example.. When the tire is ready to be removed, the user may apply pressure on the tire to cause a spring action to bounce up, causing the plate 120, 122, and 124 to return to its resting position and create some momentum to allow the tire to roll toward the plate 112 or 116 easier.

In yet another embodiment, once the plate 112 and 116 is in the activated state, the system 100 may further include an indicator or indicia 140 showing that the tire is secured. For example, the indicator may be an LED light disposed on the vertical bars 102 or the guarding bars 138. It is to be understood that the location of the indicator 140 do not limit the scope or spirit of the invention. In one aspect, the indicator may be electrically connected and activated by the hinge, the plate 112 or 116, or a combination thereof in response to the activation by the user on the handle. In another embodiment, the indicator 140 may be activated by a weight exerted on the plate 120, 122, or 124, when the indicator 140 may be electrically connected to the plate 120, 122, or 124. As such, once the plate 112 or 116 is lowered to a resting state, the indicator 140 is deactivated. It is to be understood that the activation and deactivation may be reversed, depending the preferences or configurations to show the activated state and the resting state.

In yet another embodiment, the indicator 140 may include a wireless signal transmitter for transmitting a signal to be received by a receiver. In such an example, once the indicator 140 is activated or deactivated, a signal may be sent so that the receiver, depending on the configuration, may show that the tire is in place on the section 106, 108 or 110 or otherwise.

The foregoing description of the invention has been presented for purposes of illustration and description and is not intended to be exhaustive or to limit the invention to the precise form disclosed, and obviously many modifications and variations are possible in light of the above teaching. They simulate a user facing the apparatus and various parts are numbered. The basic concept is that the user is able to use the apparatus and obtain an efficient, total body workout, by circuit training with the apparatus.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

What is claimed is:

1. A tire securing system comprising:
a rack frame having a base platform supporting a plurality of vertical bars extending vertically from three sides of the base platform, wherein the at least two of the plurality of vertical bars are reinforced by a least one substantially horizontal bar;
a movable slanted step configured at one side of the base platform, wherein the movable slanted step is configured to be activated by a first lever mechanism with a handle, wherein the movable slanted step is elevated by the activation of the handle;
wherein the movable slanted step on the one side and the plurality of vertical bars on the three sides of the base platform forms an entry way to receive one or more tires for storage;
a tire resting plate connected to base platform, wherein one end of the tire resting plate is connected to the movable slanted step via a hinge;
a tire stopper bar disposed at the other end of the tire resting plate;
a plurality of guarding bars extending diagonally from the at least one substantially horizontal bar to the base platform; and
one or more restraining lines connecting the plurality of guarding bars for securing the one or more tires.

2. The tire securing system of claim 1, wherein the one or more restraining lines comprise a chain.

3. The tire securing system of claim 2, wherein the chain is further secured to the plurality of guarding bars via a hook and a loop.

4. The tire securing system of claim 3, wherein the hook may be removably attach and detach from the loop.

5. The tire securing system of claim 1, wherein the movable slanted step, in response to the activation of the handle, is elevated to an angle above an x-axis of the tire resting plate.

6. The tire securing system of claim 1, further comprising a second lever mechanism for moving the tire resting plate with respect to the x-axis thereof.

7. The tire securing system of claim 7, wherein the second lever mechanism is activated by the handle.

8. The tire securing system of claim 6, wherein the second lever mechanism comprises a spring.

9. The tire securing system of claim 5, further comprising an indicator activated by a movement of the movable slanted step.

10. The tire securing system of claim 9, further comprising a wireless signal generator activated by the movement of the movable slanted step.

11. A tire securing rack comprising:
a base platform supporting a plurality of vertical bars extending vertically from three sides of the base platform, wherein the at least two of the plurality of vertical bars are reinforced by a least one substantially horizontal bar;
a movable plate configured at one side of the base platform, wherein the movable plate is configured to be activated by a first lever mechanism with a handle, wherein the movable plate is movable by the activation of the handle;
wherein the movable plate on the one side and the plurality of vertical bars on the three sides of the base platform forms an entry way to receive one or more tires for storage;
a tire resting plate connected to base platform, wherein one end of the tire resting plate is connected to the movable plate via a hinge;
a tire stopper bar disposed at the other end of the tire resting plate;
a plurality of guarding bars extending diagonally from the at least one substantially horizontal bar to the base platform; and
one or more restraining lines connecting the plurality of guarding bars for securing the one or more tires.

12. The tire securing rack of claim 11, wherein the one or more restraining lines comprise a chain.

13. The tire securing rack of claim 12, wherein the chain is further secured to the plurality of guarding bars via a hook and a loop.

14. The tire securing rack of claim 13, wherein the hook may be removably attach and detach from the loop.

15. The tire securing rack of claim 11, wherein the movable plate, in response to the activation of the handle, is elevated to an angle above an x-axis of the tire resting plate.

16. The tire securing rack of claim 11, further comprising a second lever mechanism for moving the tire resting plate with respect to the x-axis thereof.

17. The tire securing rack of claim 16, wherein the second lever mechanism is activated by the handle.

18. The tire securing rack of claim 16, wherein the second lever mechanism comprises a spring.

19. The tire securing rack of claim 15, further comprising an indicator activated by a movement of the movable plate.

20. The tire securing rack of claim 19, further comprising a wireless signal generator activated by the movement of the movable plate.
